(19) United States
(12) Patent Application Publication
(10) Pub. No.: US 2015/0237855 A1
(43) Pub. Date: Aug. 27, 2015

(54) MOSQUITO SOLUTIONS REPELLENT DETERGENT

(71) Applicant: Dominic Joseph Polidoro, I, Manteo, NC (US)

(72) Inventor: Dominic Joseph Polidoro, I, Manteo, NC (US)

(21) Appl. No.: 14/188,653

(22) Filed: Feb. 24, 2014

(51) Int. Cl. A01N 37/08

(52) U.S. Cl. CPC A01N 37/08

(57) ABSTRACT

Mosquito Solutions Repellent Detergent is a successful and effective combination of detergent and mosquito repellent agent, used to launder textiles or articles including but not limited to: clothing such as but not limited to shirts, jackets, shoelaces and bags or gear used for hunting, fishing or outdoor backpacking; bedding items such as but not limited to tents, nets and throw blankets; household items such as but not limited to entryway rugs, outdoor rugs, and weather-stripping for doors, windows and vents. For prevention of vector-borne illnesses and public health threats including but not limited to: Malaria, Dengue Fever, Yellow Fever, Rift Valley Fever, and Arboviral Encephalitides such as Eastern equine encephalitis, Japanese encephalitis, La Crosse encephalitis, St. Louis encephalitis, West Nile Virus and Western equine encephalitis; by creating a mosquito repellent impregnated barrier out of your clothing, bedding or other textiles.

### CROSS REFERENCE TO RELATED APPLICATIONS

None Applicable

### BACKGROUND OF THE INVENTION

This invention relates to the successful combination of detergent for textiles and a vermin repellent.

The primary vermin targeted are mosquitoes which are a concern for numerous vector borne illnesses.

A search and description of the related art did not show a single utility or idea that possessed both of the aforementioned combined. The 2 classes that this invention seemed most closely related with were class 510 of art unit 1761 as well as class D22 of art unit 2914.

### SUMMARY OF THE INVENTION

This invention effectively and successfully combines a cleaning agent for textiles with a mosquito repellent composition, allowing it to adhere to textiles including but not limited to clothing, bedding and construction or household articles or textiles.

Vector-borne illnesses, most specifically in this instance carried by mosquitoes, can be greatly reduced or even eliminated in some instances using this product in conjunction with or as an alternative to products applied directly to the skin for such causes as preventing mosquito bites which may carry and transmit these illnesses.

### DETAILED DESCRIPTION OF THE PREFERRED EMBODIMENT

To create the Mosquito Solutions Repellent Detergent combine the following: distilled water

detergent commonly known as borax (sodium borate, sodium tetra borate, disodium tetra borate)

agent commonly known as baking soda (sodium bicarbonate or sodium hydrogencarbonate)

bar of common unscented soap (sodium palmitate, lavric acid, sodium lesthionate)

bifenderine solution

Above ingredients are brought to a boil in their respective percentages, and mixed thoroughly with an electric mixer until blended smoothly to form a nearly gelatinous liquid and removed from the heat. They are allowed to cool back to room temperature retaining their nearly gelatinous liquid state and then stirred thoroughly again with an electric mixer.

3(three) fluid ounces of Mosquito Solutions Repellent Detergent is then utilized in an average or medium load of laundry washed on cold temperature on the normal wash setting or soaked in a tub of cold water that completely covers all articles in the water and solution combination for a minimum of 1 hour.

Treated articles should then be worn over untreated articles, preferably but not limited to cotton undergarments or bedding, to prevent irritation to eyes, mucosa or skin from or during activity or sweating.

The effective and proper use of the Mosquito Solutions Repellent Detergent can help in the United States for hunters and sportsmen in a recreational or travel capacity. As well it can help our U.S. military at home and abroad. It can also aid in fighting public health initiatives in global vector-borne endemics and epidemics including but not limited to malaria.

In accordance with the provisions of the patent statutes the principle and mode of operation of Mosquito Solutions Repellent Detergent have been explained here in its preferred embodiment. However, it must be understood that this invention may be practiced otherwise than as specifically explained without departing from its principle or scope.

What is claimed is:

1. Effective product which when used properly conveys vermin, namely mosquito, repellent properties to articles or textiles while they are cleansed or soaked for future use.

2. Prevention of vector-borne illnesses by proper use of above laundered articles or textiles by a person/persons or animals.
